(19) United States
(12) Patent Application Publication
(10) Pub. No.: US 2019/0304017 A1
(43) Pub. Date: Oct. 3, 2019

(54) COMPOUND-PRICE CALCULATING SYSTEM AND METHOD THEREOF

(71) Applicant: MOLBASE (SHANGHAI) BIOTECHNOLOGY CO., LTD., SHANGHAI (CN)

(72) Inventor: JUN WEN, SHANGHAI (CN)

(21) Appl. No.: 16/446,083

(22) Filed: Jun. 19, 2019

Related U.S. Application Data
(63) Continuation-in-part of application No. 14/861,241, filed on Sep. 22, 2015.
(60) Provisional application No. 62/204,893, filed on Aug. 13, 2015.

(51) Int. Cl. G06Q 40/04

(52) U.S. Cl. CPC G06Q 40/04

(57) ABSTRACT

A compound-price calculating system includes a processor and a memory that stores a program. When the processor executes the program, the processor is caused to function as a compound synthetic pathway base, a historical transaction base, and a price calculating system. The compound-price calculating system performs computing a current cost price of a target compound based on historical trade prices or current supplier's offers of the upstream compound of the target compound; computing a synthetic pathway price of the target compound based on costs of upstream compounds and a yield of the target compound; computing a total pathway price ratio; and obtaining a final suggested price of the target compound. The system and method provide authentic reference on prices for users' transactions. With addition of new information about synthetic pathways and the Internet's autonomous learning ability, the price data can be continuously updated. It is about using synthetic pathways and vertical historical prices to build a solid two-dimensional system for price expectation.

### CROSS REFERENCE TO RELATED APPLICATIONS

This application is a Continuation-in-Part of co-pending application Ser. No. 14/861,241, filed on Sep. 22, 2015, for which priority is claimed under 35 U.S.C. § 120; and this application claims priority of U.S. Provisional Application No. 62/204,893 filed on Aug. 13, 2015 under 35 U.S.C. § 119(e), the entire contents of all of which are hereby incorporated by reference.

### BACKGROUND OF THE INVENTION

### 1. Technical Field

The present invention relates to smart methods for calculating commodity prices for third-party platforms, and more particularly to a compound-price calculating system and its method.

### 2. Description of Related Art

With the rapid development of electronic commerce, there are more and more vertical search fields. Globally, the annual growth of the compound market is a high as 20%˜30%. However, compound transactions are currently still managed by trading companies in the traditional way. A compound's market price remains a mystery to both its buyers and suppliers. The market is least transparent. Before a deal is done, the buyer and the supplier have to spend considerable time on inquiry and parity. Also, in the traditional market, for maximizing profits, suppliers are usually unwilling to disclose their prices to the public. Thus, though it is possible to collect abundant information about compounds and their suppliers through the Internet, the information on prices is unknown.

Current, search engines and e-commerce platforms are open to provide useful commodity information. With proper combinations of search criteria, a user can rapidly get information about his/her target commodity, such as the names and contacts of suppliers, the properties of the commodity and other detailed descriptions. However, in many third-party platforms, the information about prices, which is what users concern most, is unavailable for some reasons. In some other cases, the suppliers may provide untruthful information, making the acquired price information far from the actual market prices. Since the suppliers are unaware of the prevalent market prices, they tend to disclose untrue prices or hide prices, and buyers thus have no confidence in such commodity information. As a result, even though a buy has spent a lot of time to ask for quotations and do comparison, he/she may still fail to buy the commodity he/she needs at a reasonable price. In general, this affects commodity transactions adversely.

### SUMMARY OF THE INVENTION

One objective of the present invention is to address the shortcomings seen in the prior art by providing a compound-price calculating system and a method thereof.

The first objective of the present invention is to provide a compound-price computing system, comprising a processor; and a memory storing a program, wherein when the program is executed by the processor, the processor is caused to function as a compound synthetic pathway base, configured to record upstream and downstream products of a compound, prices, synthetic pathways, synthetic conditions and yields of the upstream and downstream products, a historical transaction base, configured to record trade commodities, times and prices of all transactions and current supplier's offer of each said commodities, and a price calculating system, configured to store equations for calculating compound current cost price, synthetic pathway price, standard synthetic pathway prices, single pathway price ratios, total pathway price ratios and suggested prices. The price calculating system calculates the suggested price through at least the following steps:

(1) computing a current cost price of a target compound based on historical trade prices or current supplier's offers of upstream compounds of the target compound;

(2) where the target compound has multiple synthetic pathways, computing synthetic pathway prices of the target compound based on the costs of the upstream compounds and the yields of the target compound of all the synthetic pathways, and selecting the lowest synthetic pathway price as a standard synthetic pathway price;

(3) according to the standard synthetic pathway price and the current cost price, computing a single pathway price ratio, which is a proportion of the standard synthetic pathway price to the current cost price; and according to the multiple said single pathway price ratios, computing a total pathway price ratio; and

(4) obtaining a final suggested price of the target compound from the standard synthetic pathway price and the total pathway price ratio, wherein

Suggested Price=Standard Synthetic Pathway Price/Total Pathway Price Ratio.

In the compound-price computing system, Step (1) further comprising: computing an average of the historical trade prices of the upstream compounds as a standard historical trade price of the target compound:

Standard Historical Trade Price=Sum(Historical Trade Price 1+Historical Trade Price 2+ . . . +Historical Trade Price n)/(n);

computing an average of the supplier's offers of the upstream compounds as a standard supplier's offer of the target compound:

Standard Supplier's Offer=Sum(Supplier's Offer 1+Supplier's Offer 2+ . . . +Supplier's Offer n)/(n); and

taking the standard historical trade price or the standard supplier's offer as the current cost price of the target compound.

In the compound-price computing system, Step (2), the synthetic pathway price of the target compound is computed as below:

Synthetic Pathway Price=Sum(Compound's Cost Price 1+Compound's Cost Price 2+ . . . +Compound's Cost Price n)*(1−Yield %)/(n); and

the standard synthetic pathway price of the target compound is computed as below:

Standard Synthetic Pathway Price=Min(Synthetic Pathway Price 1, Synthetic Pathway Price 2, Synthetic Pathway Price 3, . . . ).

In the compound-price computing system, in Step (3),

Single Pathway Price Ratio=Standard Synthetic Pathway Price/Historical Trade Price; and

Total Pathway Price Ratio=Sum(Single Pathway Price Ratio 1+Single Pathway Price Ratio 2+ . . . +Single Pathway Price Ratio n)/(n).

To sum up, the present invention uses the compound synthetic pathway base to record the upstream and downstream products, synthetic procedures, synthetic conditions and yields of compounds. By considering and analyzing to the known prices of the upstream raw-material compound and the yield of the target commodity compound, and other price-affecting factors that influence the price, the cost price of the target commodity can be obtained. In addition, with the evolving historical transaction base, it is possible to recognize the trend of the trade prices of the related commodities, and in turn reasonably calculate the current market price. The system and method provide authentic reference on prices for users' transactions based on the cost process and the current market trade prices.

With addition of new information about synthetic pathways and the Internet's autonomous learning ability, the price data can be continuously updated. It is about using synthetic pathways and vertical historical prices to build a solid two-dimensional system for price expectation.

### BRIEF DESCRIPTION OF THE DRAWINGS

FIG. 1 is a flowchart of a compound-price calculating system and its method according to the present invention;

FIG. 2 is a schematic diagram illustrating the relation between upstream compounds and a target compound according to the present invention; and

FIG. 3 is a block diagram of the compound-price calculating system.

### DETAILED DESCRIPTION OF THE INVENTION

The following description, in conjunction with the accompanying drawings and preferred embodiments, is set forth as below to illustrate the implement, structure, features and effects of the subject matter of the present invention.

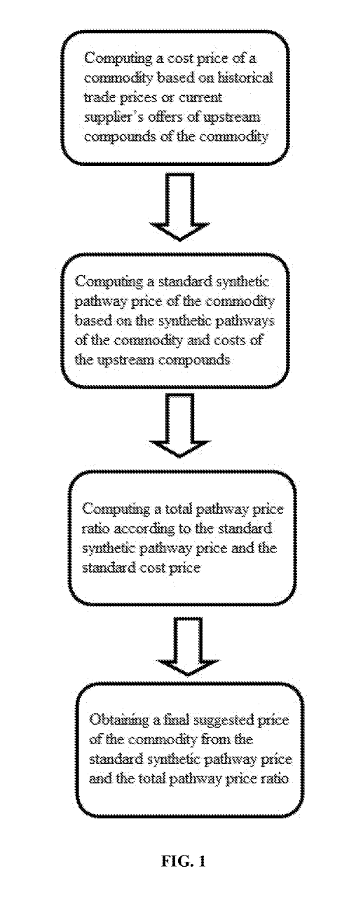

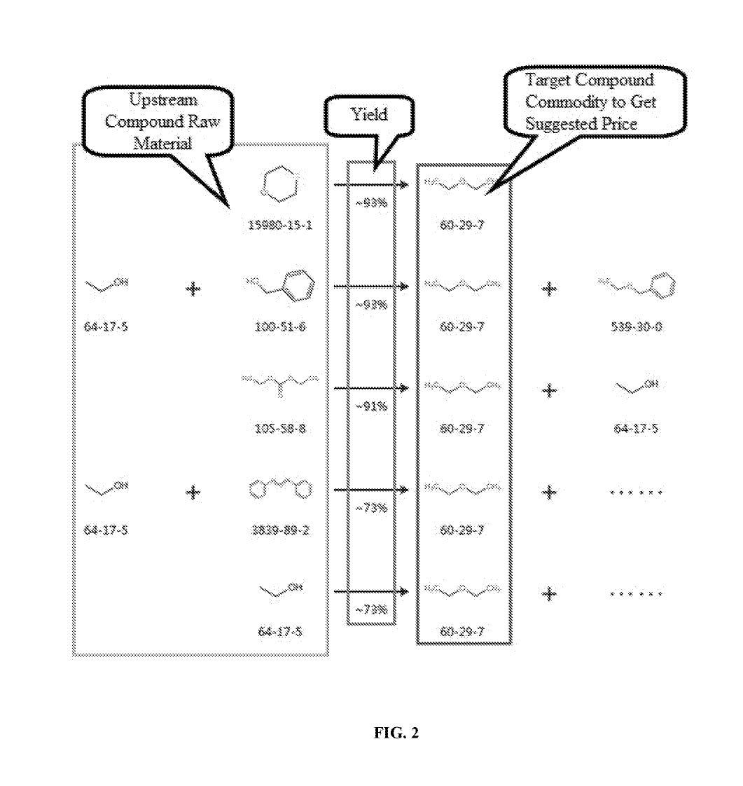

Referring to FIGS. 1 to 3, the present invention provides a compound-price calculating system that comprises a compound synthetic pathway base, a historical transaction base and a price calculating system.

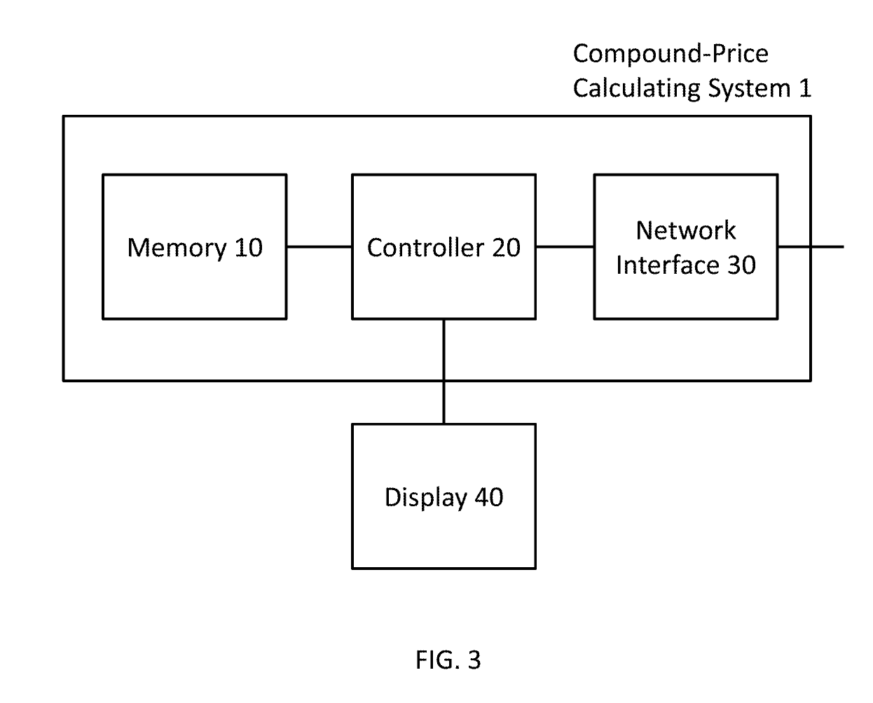

As shown in FIG. 3, a compound-price calculating system 1 includings a memory 10, a controller 20, a network interface 30 and a display 40.

The memory 10 may be a data storage medium, such as a random access memory (RAM), a read-only memory (ROM), a hard disk, a solid state disc, a compact disc or any known medium that is capable of storing data. The memory 10 stores a program for causing the controller 20 to perform various functions, such as the compound synthetic pathway base 21, the historical transaction base 22 and the price calculating system 23 when executed. The memory 10 can also store any data read, executed, and/or stored by the compound synthetic pathway base 21, the historical transaction base 22 and the price calculating system 23.

The controller 20 may be any generic computer processor unit (CPU) or a dedicated processor, microprocessor or the like that can be programed by the program stored in the memory 10 when the program is executed. When the program executed by the controller 20, the controller functions as the compound synthetic pathway base 21, the historical transaction base 22 and the price calculating system 23. The program that causes the controller 20 to function as the compound synthetic pathway base 21, the historical transaction base 22 and the price calculating system 23 may include specific algorithms that enable the below discussed functions performed by each of the compound synthetic pathway base 21, the historical transaction base 22 and the price calculating system 23, which may be apparent to those skilled in the art. The controller 20 also processes data received by the network interface 30 and outputs data to the display 40 or an exeterna device connected via the network interface 30.

The network interface 30 is an interface that is capable of receiving from and transmitting to a network-connected device, such as a server. The network may be Ethernet, Internet, Intranet, open or closed cloud base network, or the like. According to the present application, the term network includes any data bus connected via the network interface 30 to allow inputting and outputting data.

The display 40 is connected to the compound-price calculating system 1 and display information received from the controller 20.

The compound synthetic pathway base 21 causes the memory 10 to record upstream and downstream products of a compound and prices, synthetic pathways, synthetic conditions and yields of the upstream and downstream products.

The historical transaction base 22 causes the memory 10 to record trade commodities, times and prices of all transactions and current supplier's offer of each said commodity.

The price calculating system 23 causes the memory 10 to store equations for calculating compound current cost price, synthetic pathway price, standard synthetic pathway prices, single pathway price ratios, total pathway price ratios and suggested prices.

According to the present invention, a compound-price calculating method involves:

In a first step (1), by computing an average of multiple historical trade prices of the upstream compounds, the standard historical trade price of the target compound can be obtained:

Standard Historical Trade Price=Sum(Historical Trade Price 1+Historical Trade Price 2+ . . . +Historical Trade Price n)/(n).

Then by computing an average of the multiple supplier's offers of the upstream compounds, the standard supplier's offer of the target compound can be obtained:

Standard Supplier's Offer=Sum(Supplier's Offer 1+Supplier's Offer 2+ . . . +Supplier's Offer n)/(n).

The standard historical trade price or the standard supplier's offer is taken as the current cost price of the target compound. Since the historical trade price is relatively reliable, where there are historical trade prices available, the standard historical trade price is taken as the current cost price of the target compound. If there is no historical trade price available, the supplier's current offer is taken to compute the current cost price.

In a second step (2), where the target compound has multiple synthetic pathways, synthetic pathway prices of the target compound are computed based on the costs of the upstream compounds and the yields of the target compound of all the synthetic pathways. Then the lowest synthetic pathway price is taken as a standard synthetic pathway price.

The synthetic pathway price of the target compound is computed as below:

Synthetic Pathway Price=Sum(Compound's Cost Price 1+Compound's Cost Price 2+ . . . +Compound's Cost Price n)*(1−Yield %)/(n);

The standard synthetic pathway price of the target compound is computed as below:

Standard Synthetic Pathway Price=Min(Synthetic Pathway Price 1, Synthetic Pathway Price 2, Synthetic Pathway Price 3, . . . ).

Then is a third step (3). It is to be noted that in addition to the costs of the upstream materials, there are various factors affecting the actual price of a compound, such as labor costs, machine loss, environment handling and market situation. The present invention herein defines a ratio after comparing a huge amount of synthetic pathway prices and commodity actual prices, which is a proportion of the synthetic pathway price to the total cost, and is herein referred to as a “single pathway price ratio”.

According to the standard synthetic pathway price and the current cost price, the single pathway price ratio is computed:

Single Pathway Price Ratio=Standard synthetic pathway price/Historical trade price.

According to multiple single pathway price ratios, a total pathway price ratio is obtained:

total pathway price ratio=sum(single pathway price ratio 1+single pathway price ratio 2++single pathway price ratio n)/(n).

In a fourth step (4), according to the standard synthetic pathway price and the total pathway price ratio, a suggested market price of the target compound that is relatively authentic can be obtained. The equation for computing the final suggested price is:

Suggested Price=Standard synthetic pathway price/total pathway price ratio.

To sum up, the present invention uses the compound synthetic pathway base 21 to record the upstream and downstream products, synthetic procedures, synthetic conditions and yields of compounds. By considering and analyzing to the known prices of the upstream raw-material compound and the yield of the target commodity compound, and other price-affecting factors that influence the price, the cost price of the target commodity can be obtained. In addition, with the evolving historical transaction base 22, it is possible to recognize the trend of the trade prices of the related commodities, and in turn reasonably calculate the current market price. The system and method provide authentic reference on prices for users' transactions based on the cost process and the current market trade prices.

With addition of new information about synthetic pathways and the Internet's autonomous learning ability, the price data can be continuously updated. It is about using synthetic pathways and vertical historical prices to build a solid two-dimensional system for price expectation.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A compound-price computing system, comprising:
a processor; and
a memory storing a program, wherein
when the program is executed by the processor, the processor is caused to function as:
a compound synthetic pathway base, configured to record upstream and downstream products of a compound, prices, synthetic pathways, synthetic conditions and yields of the upstream and downstream products;
a historical transaction base, configured to record trade commodities, times and prices of all transactions and current supplier's offer of each said commodities; and
a price calculating system, configured to store equations for calculating compound current cost price, synthetic pathway price, standard synthetic pathway prices, single pathway price ratios, total pathway price ratios and suggested prices;
wherein the price calculating system calculates the suggested price through at least the following steps:
(1) computing a current cost price of a target compound based on historical trade prices or current supplier's offers of upstream compounds of the target compound;
(2) where the target compound has multiple synthetic pathways, computing synthetic pathway prices of the target compound based on the costs of the upstream compounds and the yields of the target compound of all the synthetic pathways, and selecting the lowest synthetic pathway price as a standard synthetic pathway price;
(3) according to the standard synthetic pathway price and the current cost price, computing a single pathway price ratio, which is a proportion of the standard synthetic pathway price to the current cost price; and according to the multiple said single pathway price ratios, computing a total pathway price ratio; and
(4) obtaining a final suggested price of the target compound from the standard synthetic pathway price and the total pathway price ratio, wherein
Suggested Price=Standard Synthetic Pathway Price/Total Pathway Price Ratio.

2. The compound-price computing system of claim 1, wherein Step (1) further comprising: computing an average of the historical trade prices of the upstream compounds as a standard historical trade price of the target compound:
Standard Historical Trade Price=Sum(Historical Trade Price 1+Historical Trade Price 2+ . . . +Historical Trade Price n)/(n);
computing an average of the supplier's offers of the upstream compounds as a standard supplier's offer of the target compound:
Standard Supplier's Offer=Sum(Supplier's Offer 1+Supplier's Offer 2+ . . . +Supplier's Offer n)/(n); and
taking the standard historical trade price or the standard supplier's offer as the current cost price of the target compound.

3. The compound-price computing system of claim 1, wherein in Step (2), the synthetic pathway price of the target compound is computed as below:
Synthetic Pathway Price=Sum(Compound's Cost Price 1+Compound's Cost Price 2+ . . . +Compound's Cost Price n)*(1−Yield %)/(n); and
the standard synthetic pathway price of the target compound is computed as below:
Standard Synthetic Pathway Price=Min(Synthetic Pathway Price 1, Synthetic Pathway Price 2, Synthetic Pathway Price 3, . . . ).

4. The compound-price computing system of claim 1, wherein in Step (3),
Single Pathway Price Ratio=Standard Synthetic Pathway Price/Historical Trade Price; and
Total Pathway Price Ratio=Sum(Single Pathway Price Ratio 1+Single Pathway Price Ratio 2+ . . . +Single Pathway Price Ratio n)/(n).
